(19) United States
(12) Patent Application Publication
(10) Pub. No.: US 2026/0346799 A1
(43) Pub. Date: Nov. 5, 2026

(54) Method and Apparatus for Monitoring a Motor Vehicle

(71) Applicant: Bayerische Motoren Werke Aktiengesellschaft, Muenchen (DE)

(72) Inventors: David Kragl, Zolling (DE); Stephan Ludwig, Muenchen (DE); Benjamin Schuster, Muenchen (DE); Marcel Sieber, Muenchen (DE); David Hearn, Garching bei Muenchen (DE)

(21) Appl. No.: 19/118,821

(22) PCT Filed: Jun. 28, 2023
(86) PCT No.: PCT/EP2023/067619

§ 371 Date: Apr. 7, 2025

(30) Foreign Application Priority Data
Oct. 19, 2022 (DE) 10 2022 127 608.2

(51) Int. Cl. E05F 15/71; B60Q 9/00; B60R 11/00; B60R 11/04; G01P 15/00

(52) U.S. Cl. CPC E05F 15/71; B60Q 9/00; B60R 11/04; B60R 2011/004; E05Y 2400/81; E05Y 2900/531; E05Y 2900/548; G01P 15/00

(57) ABSTRACT

A method for monitoring a motor vehicle includes detecting hail using at least in part a sensor system of the motor vehicle. The sensor system includes at least one acceleration sensor. The occurrence of hail is established based on acceleration pulses that are detected by the at least one acceleration sensor. The method further includes triggering an execution of one or more predefined actions by the motor vehicle when the occurrence of hail is established.

The present application is the U.S. national phase of PCT Application PCT/EP2023/067619 filed on Jun. 28, 2023, which claims priority of German patent application No. 10 2022 127 608.2 filed on Oct. 19, 2022, the entire contents of which are incorporated herein by reference.

### TECHNICAL FIELD

The disclosure relates to the field of monitoring of motor vehicles.

### BACKGROUND

Detecting the weather conditions at the location of a motor vehicle and initiating measures to protect the motor vehicle if necessary is known from the prior art. For example, document DE 10 2007 040 055 A1 discloses a motor vehicle having a closable convertible top, wherein if rain, hail, or a low ambient temperature is detected by means of a detection device of the motor vehicle, the open convertible top is closed.

There is a need to improve the monitoring of a motor vehicle with respect to the occurrence of hail.

### SUMMARY

The above-described need, as well as others, are satisfied by at least some embodiments disclosed herein.

A method disclosed herein is used for monitoring a motor vehicle, wherein the motor vehicle is preferably a passenger vehicle, but can possibly also be a truck. The monitored motor vehicle is preferably parked. Hail can be detected using the motor vehicle, wherein the motor vehicle triggers the execution of one or more predefined actions by the motor vehicle when hail is detected.

At least some embodiments of the method is distinguished in that the detection of hail is carried out by means of a sensor system installed in the motor vehicle, which comprises at least one acceleration sensor, wherein the occurrence of hail is established based on acceleration pulses which are detected by the at least one acceleration sensor.

Some embodiments of the method enable a very reliable detection of hail by the use of one or more acceleration sensors, so that corresponding actions which are coupled to the detection of hail are also always only executed by the motor vehicle when hail actually occurs.

In one embodiment, the sensor system contains a single acceleration sensor, by which costs are saved. In a further preferred variant, the at least one acceleration sensor is installed in the roof of the motor vehicle. The detection of hail strikes s is ensured very well at all points of the motor vehicle by this central installation location. Alternatively, the at least one acceleration sensor can also be installed at another point in the motor vehicle or multiple further acceleration sensors can be provided, which are installed at points other than in the roof of the motor vehicle. For example, an acceleration sensor can also be integrated into the engine hood or into the rear of the motor vehicle.

In a further embodiment of the method, the predefined action or the predefined actions comprise an optical and/or acoustic signal recording on the motor vehicle. Such a signal recording is to be understood as the capture of optical or acoustic signals and the storage thereof. In this way, the occurrence of hail can be suitably documented. The signal recording on the motor vehicle preferably comprises the capture of one or more images on the motor vehicle by means of one or more cameras of the motor vehicle, in particular by means of one or more exterior cameras for capturing the surroundings of the motor vehicle and/or by means of one or more interior cameras for capturing the interior or passenger compartment of the motor vehicle. In one particularly preferred variant, a video is recorded by the camera or cameras which possibly also includes a sound recording in order to acoustically record the impacts of the hailstones.

In a further embodiment, the predefined action or the predefined actions comprise the emission of a message by the motor vehicle, wherein the message is designed such that it triggers the output of a warning via a user interface of a terminal assigned to the motor vehicle in order to inform a user of the terminal about the detected hail. This variant provides the possibility that the user is informed in a timely manner about the occurrence of hail and can take countermeasures if necessary. In particular, they can go to their motor vehicle and drive it to a point at which the motor vehicle is protected (for example, a parking garage).

The terminal of the user is preferably a mobile terminal and in particular a mobile telephone. Nonetheless, the terminal can also be any arbitrary other terminal having a corresponding user interface, e.g., a laptop, a tablet, or possibly also a stationary computer. In a preferred variant, the warning is output optically via a display of the terminal, i.e. the user interface of the terminal comprises a display. Alternatively or additionally, the user interface can also comprise an acoustic input and/or output means and/or a haptic input and/or output means.

In a further variant, one or more control instructions are selectable by the user via the user interface of the terminal upon output of the warning via the user interface of the terminal, wherein an operation of the motor vehicle is assigned to a respective selectable control instruction, wherein, triggered by the terminal, upon selection of a respective control instruction by the user, the operation which is assigned to the respective selected control instruction is executed by the motor vehicle. In this way, the remote actuation of the motor vehicle upon the occurrence of hail is made possible for the user of the terminal. The selection of a control instruction is preferably carried out via touching the control instruction on a display of the terminal or via operating separate buttons on the terminal.

An operation is distinguished from the above predefined actions in that an operation is executed triggered by the user of the terminal and not triggered by the motor vehicle. Nonetheless, an operation can also comprise the closing of accesses described further below or the optical and/or acoustic signal recording described above. If this is the case, the predefined action or actions, which are executed triggered by the motor vehicle, are actions other than the closing of open accesses or the optical and/or acoustic signal recording.

In other embodiments, the predefined action or the predefined actions comprise the closing of one or more open accesses to the interior and/or to the baggage compartment of the motor vehicle. In particular, in this case open windows and/or open entry doors and/or an open rear hatch and/or an open baggage compartment lid and/or an open convertible top can be closed in case of hail. In this way, hail damage in the interior of the motor vehicle is reliably avoided.

In further embodiments, the strength and/or direction of the acceleration of the respective acceleration pulses and/or the average frequency of the occurrence of acceleration pulses within the predetermined time span (i.e. the frequency averaged over the predetermined time span) is determined by means of the sensor system from the acceleration pulses which occur within a predetermined time span. The occurrence of hail is established by the sensor system here when the strength and/or direction of the respective acceleration pulses and/or the average frequency of the occurrence of the acceleration pulses meet a predetermined criterion. The knowledge is made use of in this case that the above-mentioned variables are very well suitable for distinguishing hail from other types of precipitation or other exertions of force on the motor vehicle.

In some variants of the above-described embodiment, the occurrence of hail is established by the sensor system according to the predetermined criterion if the strengths of the accelerations of a minimum number of acceleration pulses and in particular all acceleration pulses within the predetermined time span each deviate less than a predetermined acceleration threshold value from the mean value of the strengths of the accelerations of all acceleration pulses within the predetermined time span. An additional or alternative condition for establishing hail can be given in that the directions of the accelerations of a minimum number of acceleration pulses and in particular all acceleration pulses within the predetermined time span each deviate by less than a predetermined angle threshold value from the vertical direction downward (i.e. the direction of gravity). An additional or alternative condition for establishing hail can be given in that the average frequency of the occurrence of the acceleration pulses within the predetermined time span exceeds a predefined frequency threshold value. The occurrence of hail is preferably only established when all three above conditions are met. The knowledge is made use of in this embodiment that hail is accompanied by a large number of acceleration pulses of similar strength in short time having an acceleration from top to bottom.

In addition to the above-described method, the disclosure relates to a motor vehicle, wherein hail can be detected by the motor vehicle and the motor vehicle is designed such that the motor vehicle triggers the execution of one or more predefined actions by the motor vehicle when hail is detected. The motor vehicle contains a sensor system for detecting hail, which comprises at least one acceleration sensor, wherein the sensor system is designed such that the occurrence of hail is established based on acceleration pulses, which are detected by the at least one acceleration sensor. The motor vehicle carries out one or more variants of the method disclosed herein.

The above-described features and advantages, as well as others, will become more readily apparent to those of ordinary skill in the art by reference to the following detailed description and accompanying drawings.

### BRIEF DESCRIPTION OF THE DRAWING

FIG. 1 shows a schematic representation of a motor vehicle, in which an embodiment of a of monitoring a motor vehicle may be carried out.

### DETAILED DESCRIPTION

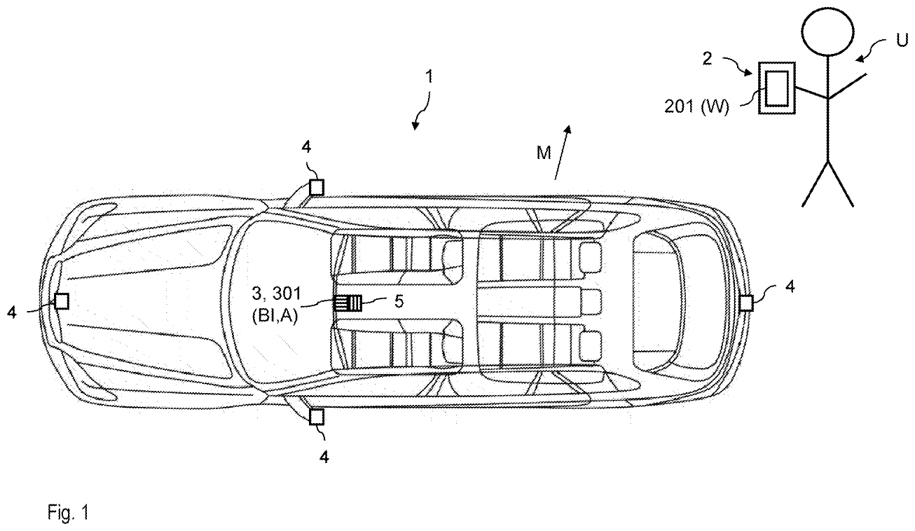

FIG. 1 schematically shows a parked motor vehicle 1 in a top view, wherein only components of the motor vehicle which are essential for clarity of exposition are explained hereinafter. In addition, FIG. 1 shows a schematic representation of a terminal 2, which comprises a user interface in the form of a display 201, wherein the terminal is operated by a user U.

The motor vehicle 1 comprises a sensor system 3 having an acceleration sensor 301. This sensor system and the acceleration sensor integrated therein are schematically indicated in FIG. 1 by a square having horizontal shading. The sensor system 3 is integrated into the roof of the motor vehicle and enables a very reliable identification of hail based on corresponding acceleration pulses BI, which are detected by the acceleration sensor 301. These acceleration pulses are evaluated by means of a processor (not shown) of the sensor system, in order to establish the occurrence of hail via this. The processor does not necessarily have to be installed in the roof of the motor vehicle here, but rather it can possibly also be provided at another point in the motor vehicle. The position of the sensor system or the acceleration sensor in the roof is also only by way of example. In particular, the acceleration sensor can also be arranged at another location in the motor vehicle, for example, in the engine hood. Furthermore, multiple acceleration sensors can possibly be installed at different positions in the motor vehicle for the detection of acceleration pulses.

In the embodiment described here, the strength and direction of the acceleration of the respective acceleration pulses and the average frequency of the occurrence of the acceleration pulses within the predetermined time span are determined by means of the sensor system 3 from the acceleration pulses BI, which are detected within a predetermined time span by the acceleration sensor 301, wherein the occurrence of hail is established when the strength and direction of the respective acceleration pulses and the average frequency of the occurrence of the acceleration pulses meet a predetermined criterion.

In the embodiment described here, the criterion is defined such that the occurrence of hail is established by the sensor system when the strengths of the accelerations of all acceleration pulses within the predetermined time span each deviate by less than a predetermined acceleration threshold value from the mean value of the strengths of the accelerations of all acceleration pulses within the predetermined time span and when the directions of the accelerations of all acceleration pulses within the predetermined time span each deviate by less than a predetermined angle threshold value from the vertical direction downward (i.e. the direction of gravity) and when the average frequency of the occurrence of the acceleration pulses exceeds a predetermined frequency threshold value. Hail is only established in the embodiment described here when all three of the above conditions are met. The knowledge is made use of in this case that a large number of acceleration pulses in a short time having similar strengths and accelerations from top to bottom are a clear indication of hail. Nonetheless, the criterion for the detection of hail can possibly also be designed differently or also can comprise other or further conditions, for example, a minimum strength of the acceleration pulses which occur in the predetermined time span.

According to FIG. 1, the motor vehicle 1 furthermore comprises four exterior cameras, which are identified by reference sign 4 and are schematically indicated by white squares. One exterior camera is located centrally in the front of the motor vehicle, one exterior camera is installed in the right exterior mirror of the motor vehicle, another exterior camera is installed in the left exterior mirror of the motor vehicle, and a further exterior camera is arranged centrally in the rear of the motor vehicle. In a way known per se, a 360° all-around view around the motor vehicle can be acquired using the exterior cameras. In addition to the exterior cameras 4, the motor vehicle 1 contains an interior camera 5 integrated into the interior trim of the roof, which is schematically indicated as a square having vertical shading. The interior of the motor vehicle can be recorded using this camera. The number and positions of the exterior and interior cameras are solely by way of example and can also be selected differently.

If it is established on the basis of the acceleration pulses BI of the acceleration sensor 301 that hail is occurring on the motor vehicle, predetermined actions are triggered immediately by the motor vehicle 1, which are solely generally identified by reference sign A in FIG. 1. In the embodiment described here, upon the detection or identification of hail, a message M is emitted by a wireless communication interface of the motor vehicle as an action, which is indicated by an arrow. The message M reaches a backend via a communication infrastructure known per se, which causes a further message to be sent to the terminal 2. The further message, which is received via a wireless communication interface at the terminal 2, has the result that a warning W is output on the display 201 of the terminal 2. The user U is informed about the occurrence of hail at their motor vehicle by this warning. The user can then initiate corresponding countermeasures. In particular, they can go to their motor vehicle and move it into safety from the hail, by which hail damage can be avoided.

As a further action A, a video recording is begun by means of the four exterior cameras 4 and the interior camera 5 if hail is detected in the embodiment described here, wherein sound is also captured at the same time with the video recording via microphones (not shown). The video recording is stored in a corresponding memory in the motor vehicle or can possibly also be uploaded to a remote memory location outside the motor vehicle. The video recording is used for documentation that hail has actually occurred at the motor vehicle. The user of the motor vehicle therefore has proof for their insurance that any damage to the motor vehicle is caused by hail.

As a further action A, the closing of open accesses to the interior and to the baggage compartment of the motor vehicle upon detection of hail is triggered by the motor vehicle in the embodiment described here, if corresponding accesses are open. In particular, open windows or an open baggage compartment lid or an open rear hatch or open entry doors are automatically closed by the motor vehicle. It is ensured in this way that hail stones cannot penetrate into the interior of the motor vehicle and cause damage there.

In a modified embodiment, in addition to the warning W, control instructions are displayed to the user U on the display 201, which this user can select in order to trigger predetermined operations on the motor vehicle in this way. In other words, upon selection of the corresponding control instruction, a message is sent by the terminal 2, which triggers the sending of a further message to the motor vehicle in a backend, wherein the further message results in the motor vehicle in the execution of the corresponding operation. An operation is distinguished from the above-described actions A in that it is triggered by the user U and not automatically by the motor vehicle 1 upon identification of hail.

The embodiments of the invention described above have an array of advantages. In particular, the detection of hail on the motor vehicle is enabled very reliably via a sensor system having an acceleration sensor. In addition, suitable measures are provided, using which hail damage can be counteracted and the occurrence of hail is documented.

### LIST OF REFERENCE SIGNS

1 motor vehicle
2 terminal
201 user interface (display)
3 sensor system for detecting hail
4 exterior cameras
5 interior camera
M message
BI acceleration pulses
A actions
U user
W warning

1.-10. (canceled)

11. A method for monitoring a motor vehicle, comprising:
detecting hail using at least in part a sensor system of the motor vehicle, the sensor system comprising at least one acceleration sensor, wherein an occurrence of hail is established based on acceleration pulses that are detected by the at least one acceleration sensor; and
triggering an execution of one or more predefined actions by the motor vehicle when the occurrence of hail is established.

12. The method as claimed in claim 11, wherein sensor system comprises a single acceleration sensor.

13. The method as claimed in claim 12, wherein the single acceleration sensor is installed in a roof of the motor vehicle.

14. The method as claimed in claim 11, wherein the at least one acceleration sensor is installed in a roof of the motor vehicle.

15. The method as claimed in claim 14, wherein:
the one or more predefined actions includes an optical or acoustic signal recording on the motor vehicle.

16. The method as claimed in claim 15, wherein:
the one or more predefined actions includes a capture of one or more images on the motor vehicle using one or more cameras of the motor vehicle.

17. The method as claimed in claim 11, wherein:
the one or more predefined actions includes an optical or acoustic signal recording on the motor vehicle.

18. The method as claimed in claim 17, wherein:
the one or more predefined actions includes a capture of one or more images on the motor vehicle using one or more cameras of the motor vehicle.

19. The method as claimed in claim 17, wherein:
the one or more predefined actions includes sending a message by the motor vehicle, wherein the message is configured to trigger an output of a warning via a user interface of a terminal assigned to the motor vehicle in order to inform a user of the terminal about the occurrence of the hail.

20. The method as claimed in claim 11, wherein:
the one or more predefined actions includes sending a message by the motor vehicle, wherein the message is configured to trigger an output of a warning via a user interface of a terminal assigned to the motor vehicle in order to inform a user of the terminal about the occurrence of the hail.

21. The method as claimed in claim 11, wherein the one or more predefined actions includes closing of one or more open accesses to an interior of the motor vehicle.

22. The method as claimed in claim 11, wherein the one or more predefined actions includes closing of one or more open accesses to a baggage compartment of the motor vehicle.

23. The method as claimed in claim 11, wherein triggering the execution of the one or more predefined actions further comprises determining whether a hail characteristic meets predetermined criterion, and wherein the occurrence of the hail is established at least in part responsive to the hail characteristic meeting the predetermined criterion, wherein the hail characteristic comprises at least one of the group consisting of:
a strength of an acceleration of the acceleration pulses;
a direction of the acceleration of the acceleration pulses;
an average frequency of occurrence of the acceleration pulses within the predetermined time span.

24. The method as claimed in claim 23, wherein the occurrence of the hail is established by the sensor system according to the predetermined criterion when strengths of accelerations of a minimum number of acceleration pulses within the predetermined time span each deviate by less than a predefined acceleration threshold value from a mean value of the strengths of the accelerations of all acceleration pulses within the predetermined time span.

25. The method as claimed in claim 23, wherein the occurrence of the hail is established by the sensor system according to the predetermined criterion when the directions of the accelerations of a minimum number of the acceleration pulses within the predetermined time span each deviate by less than a predefined angle threshold value from a vertical direction downward.

26. The method as claimed in claim 23, wherein the occurrence of hail is established by the sensor system according to the predetermined criterion when the average frequency of the occurrence of the acceleration pulses within the predetermined time span exceeds a predefined frequency threshold value.

27. A motor vehicle configured to carry out a method as claimed in claim 11.

28. A motor vehicle, configured to detect hail and configured to triggers one or more predefined actions when hail is detected, comprising:
a sensor system configured to detect hail, the sensor system having at least one acceleration sensor, wherein the sensor system is configured to establish the occurrence of hail based on acceleration pulses, which are detected by the at least one acceleration sen
